(19) United States
(12) Patent Application Publication
(10) Pub. No.: US 2025/0067617 A1
(43) Pub. Date: Feb. 27, 2025

(54) Systems and Methods for Detecting Leaks from Liquid Flow into an Ion Source of a Mass Spectrometry System

(71) Applicant: DH Technologies Development Pte. Ltd., Singapore (SG)

(72) Inventors: Amit PATEL, Shrewsbury, MA (US); Aaron STELLA, Concord (CA)

(73) Assignee: DH Technologies Development Pte. Ltd., Singapore (SG)

(21) Appl. No.: 18/718,916

(22) PCT Filed: Dec. 13, 2022
(86) PCT No.: PCT/IB2022/062143

§ 371 Date: Jun. 12, 2024

Related U.S. Application Data
(60) Provisional application No. 63/291,017, filed on Dec. 17, 2021.

(51) Int. Cl. G01M 3/20

(52) U.S. Cl. CPC G01M 3/202

(57) ABSTRACT

Leak detection systems and methods in accordance with various aspects of the present teachings can, in various embodiments, sequester fluid leaking from the interface between a sample source and the inlet of the ion source, alert an operator as to a leak condition, and/or automatically terminate the experiment. In various aspects, a liquid leak detection system is accordance with the present teachings comprises a collection basin configured to couple to a proximal end of a conduit in fluid communication with a discharge end of an ion source of a mass spectrometer such that the proximal end of the conduit extends through the internal volume of the basin. The system may also comprise a drainage tube having an inlet end opening into an internal volume of the collection basin and configured to drain liquid therefrom, a sensor disposed within the basin or the drainage tube and configured to generate a signal indicative of liquid therewithin, and a processor that is configured to cause a user to be alerted and/or cause an experiment to be terminated upon receiving from the sensor a signal indicative of a leak.

### FIELD

The present teachings generally relate to the delivery of a liquid sample to an ion source of a mass spectrometry (MS) system, and more particularly, to methods and systems for detecting leaks when delivering such a liquid sample to the ion source.

### BACKGROUND

Mass spectrometry (MS) is an analytical technique for measuring the mass-to-charge ratios (m/z) of molecules within a sample, with both quantitative and qualitative applications. For example, mass spectrometry can be used to identify unknown compounds in a test substance, determine the isotopic composition of elements in a specific molecule, determine the structure of a particular compound by observing its fragmentation, and/or quantify the amount of a particular compound in a test sample. MS typically involves converting the sample molecules into ions using an ion source and separating and detecting the ionized molecules with electric and/or magnetic fields due to differences in their m/z using one or more mass analyzers.

MS experiments also often take advantage of orthogonal separation techniques to separate sample components prior to delivering a liquid sample to the ion source. By way of example, liquid chromatography (LC) is a well-known technique used to separate and analyze compounds from a sample mixture over time prior to subjecting the compounds to MS. In some in-line LC/MS systems, for example, a mobile phase containing analytes of interest may be passed through an LC column having an adsorbent stationary phase such that particular analytes elute from the column at different times depending on their relative affinity for the mobile and stationary phases. The eluate from the LC column may be continuously delivered to the ion source, where analytes within the solvent may be ionized and subjected to MS techniques.

Due to the accuracy and sensitivity requirements of most MS applications, liquid samples delivered to the ion source are generally delivered to the ion source using precise pumping mechanisms in order to generate a stable ion signal in a downstream mass analyzer. Because some experiments require operating the MS system for extended periods of time, operators may initiate the delivery of the liquid sample to the ion source and allow the experiment to run unattended (e.g., overnight). However, if a leak of liquid sample being delivered to the ion source goes unnoticed during an extended sample run, for example, conventional systems may not generate useful data and/or the leak could damage nearby equipment and create a laboratory hazard.

There remains a need for improved systems for delivering a liquid sample to an ion source of a mass spectrometer.

### SUMMARY

The present teachings generally relate to systems and methods for detecting leaks when delivering a liquid sample to an ion source of a MS system. Leak detection systems and methods in accordance with certain aspects of the present teachings may be particularly effective at identifying a leak at the fluidic coupling of the sample source to the inlet of the ion source, one of the most common fault locations, for example, due to faulty fitting. In various aspects, systems and methods described herein may not only identify the leak, but additionally alert an operator and/or divert the leaking liquid to a waste container to prevent damage and unsafe conditions.

In accordance with various aspects of the present teachings, a liquid leak detection system is provided, the system comprising a collection basin for containing an internal volume, wherein the basin is configured to couple to a proximal end of a conduit in fluid communication with a discharge end of an ion source of a mass spectrometer such that the proximal end of the conduit extends through the internal volume of the basin. The system may also comprise a drainage tube having an inlet end opening into the internal volume of the collection basin and configured to drain liquid therefrom and a sensor disposed within the basin or the drainage tube. The sensor may be configured to generate a signal indicative of liquid within the internal volume of the basin or the drainage tube. By way of example, in certain aspects, the sensor may be coupled to a processor that is configured to cause a user to be alerted and/or cause an experiment to be terminated upon receiving from the sensor a signal indicative of a leak.

In various aspects, the drainage tube may comprise an outlet end configured to discharge liquid received through the inlet end. For example, in certain aspects, the system may further comprise a waste container for receiving liquid discharged from the outlet end of the drainage tube.

The collection basin can have a variety of configurations, shapes, and sizes. By way of example, in certain aspects the collection basin can comprise a base and a sidewall. The proximal end of the conduit may extend through the base such that the base is disposed below the level of the proximal end of the conduit. For example, liquid leaking from the proximal end of the conduit of the ion source could flow due to gravity into the collection basin. In certain aspects, the base may be disposed between the proximal end of the conduit and the discharge end of the ion source.

The proximal end of the conduit of the ion source may be coupled to a sample source in a variety of manners. For example, the sample source may comprise a LC column and the outlet of the LC column may be configured to couple to the proximal end of the conduit of the ion source. In some related aspects, the collection basin may be disposed within a column oven. In certain aspects, the sensor may be disposed within the oven or outside the oven, for example, within the drainage tube which extends from the oven. Alternatively, the sample source may comprise a reservoir of the liquid sample and a sample conduit may be configured to be coupled to the proximal end of the conduit of the ion source. In certain aspects, the system may comprise a pumping mechanism for transporting fluid from the reservoir through the sample conduit.

In certain aspects, the proximal end of the conduit may comprise a fluid connector for coupling to the sample source. In some related aspects, for example, the outlet of an LC column may be configured to couple to the fluid connector at the proximal end of the conduit. In addition to detecting and/or capturing liquid leaking from the proximal end of the conduit of the ion source, a leak from an inlet of the LC column may also flow into the collection basin. Alternatively, in some aspects, a sample conduit for transporting liquid from a reservoir of liquid sample may terminate in a distal end configured to couple to the fluid connector at the proximal end of the conduit of the sample source.

In certain aspects, the ion source may comprise an electrospray probe configured to discharge the liquid sample from the discharge end into an ionization chamber having an orifice for receiving ions into the mass spectrometer.

The sensor may be disposed in a variety of locations. By way of example, in certain aspects, the sensor may be configured to detect liquid within the internal volume of the collection basin. Alternatively, the sensor may be configured to detect liquid within the drainage tube. Additionally, the sensor may have a variety of configurations for detecting fluid. For example, in certain aspects, the sensor may be configured to detect changes in capacitance due to the presence of fluid in the basin and/or drainage tube.

In accordance with various aspects of the present teachings, a method of operating a mass spectrometer is provided, the method comprising receiving from a sensor a signal indicative of liquid within a collection basin or a drainage tube associated with the mass spectrometer. The basin may be coupled to a proximal end of a conduit in fluid communication with a discharge end of an ion source of the mass spectrometer such that the proximal end of the conduit extends into an internal volume of the collection basin, and the drainage tube may comprise an inlet end opening into the internal volume and be configured to drain liquid therefrom. In various aspects, the sensor may be disposed within at least one of the basin or the drainage tube. Additionally, the method may comprise causing a user of the mass spectrometer to be alerted of a leak condition based on the signal received from the sensor. Additionally or alternatively, the method may comprise causing an experiment utilizing the ion source and the mass spectrometer to be terminated based on the signal received from the sensor. In various aspects, the alert and/or termination may be performed automatically (e.g., without user intervention) based on the signal received from the sensor.

These and other features of the applicant's teachings are set forth herein.

### BRIEF DESCRIPTION OF THE DRAWINGS

The skilled person in the art will understand that the drawings, described below, are for illustration purposes only. The drawings are not intended to limit the scope of the applicant's teachings in any way.

FIG. 1 schematically depicts an example leak detection system in accordance with various aspects of the applicant's teachings coupled to an ion source interfaced with a curtain plate of a mass spectrometer.

FIG. 2 schematically depicts another example leak detection system in accordance with various aspects of the applicant's teachings.

FIG. 3 schematically depicts another example leak detection system in accordance with various aspects of the applicant's teachings.

FIG. 4 schematically depicts another example leak detection system in accordance with various aspects of the applicant's teachings.

FIG. 5 is a block diagram that illustrates a computer system, upon which aspects of embodiments of the present teachings may be implemented in accordance with various aspects of the applicant's teachings.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein mean 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

Liquid samples are typically delivered to the ion source of MS systems at sufficiently low volumetric flow rates that leakage may not be immediately apparent by human observation. Though such a leak may be difficult to initially observe by an operator upon initiating an MS experiment, continued leakage throughout an unattended, extended sample run may nonetheless result in wasting costly resources, the generation of erroneous data, costly damage to nearby equipment, and/or hazardous laboratory conditions. However, leak detection systems and methods in accordance with various aspects of the present teachings may not only sequester any fluid leaking from the most common fault location at the interface between the sample source and the inlet of the ion source, but also be able to able to alert an operator and/or automatically terminate the experiment.

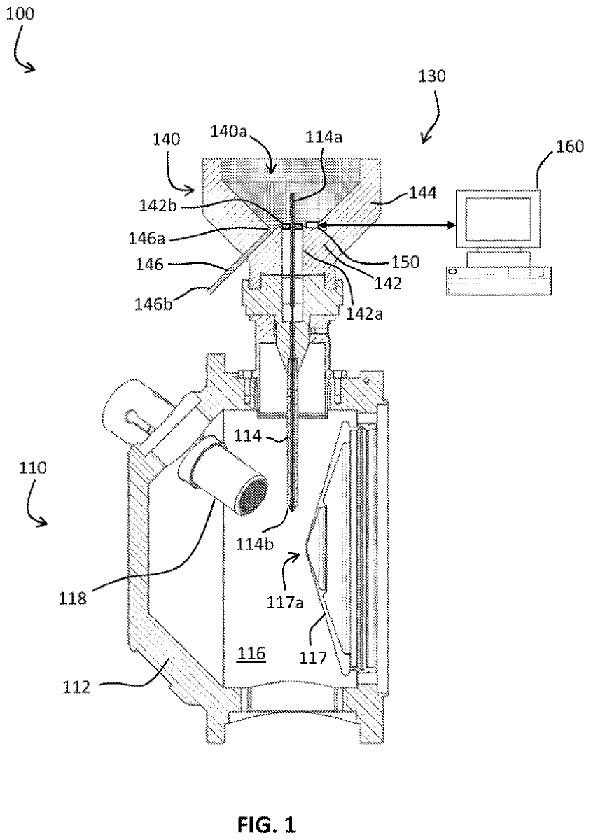

With reference now to FIG. 1, an example MS system 100 having a leak detection system 130 in accordance with various aspects of the present teachings is schematically depicted. As shown, the leak detection system 130 is generally configured to detect and/or capture leakage at the interface between a sample source (not shown) and the example ion source 110. The example leak detection system 130 generally comprises a collection basin 140 into which leaked fluid can flow, a sensor 150 for generating a signal indicative of the presence of leaked fluid, and a computer system 160 communicatively coupled to the sensor 150 for receiving the signal generated thereby.

As shown, the example ion source 110 comprises a housing 112 providing a port 112a for coupling an electrospray ion probe 114 to the housing 112. In the example ion source 110 of FIG. 1, the ion probe 114 comprises an electrospray electrode defining a conduit that terminates in a distal, outlet end 114b that at least partially extends into an ionization chamber 116 to discharge the liquid sample therein. As shown, a proximal, inlet end 114a of the conduit extends from the housing 112 and is configured to fluidly couple to a sample source (not shown) through one or more conduits, channels, tubing, pipes, capillary tubes, etc. It will be appreciated that the sample source can be any suitable sample inlet system known in the art. By way of non-limiting example, the ion source 140 can be configured to fluidically couple to a variety of sample sources via the inlet end 114a, including a reservoir containing a fluid sample that is delivered to the sample source (e.g., pumped) or via an injection of a sample into a carrier liquid, a sample separation device utilizing techniques such as an in-line liquid chromatography (LC) column that is configured to separate one or more compounds from a sample over time.

As will be appreciated by a person skilled in the art in light of the present teachings, the outlet end 114b of the probe 114 can atomize, aerosolize, nebulize, or otherwise discharge (e.g., spray with a nozzle) liquid sample into the ionization chamber 116 to form a sample plume comprising a plurality of micro-droplets generally directed toward (e.g., in the vicinity of) a curtain plate opening 117a within curtain plate 117. As is known in the art, analytes contained within the micro-droplets can be ionized (i.e., charged) by the ion source 110, for example, as the sample plume is generated. By way of non-limiting example, the outlet end 114b of the electrospray electrode probe 114 can be made of a conductive material and electrically coupled to a pole of a voltage source (not shown), while the other pole of the voltage source can be grounded. Micro-droplets contained within the sample plume can thus be charged by the voltage applied to the outlet end 114b such that as the desorption solvent within the droplets evaporates during desolvation in the ionization chamber 116 bare charged analyte ions are released and drawn toward the opening 117a, which is in communication with a downstream mass spectrometer (e.g., one or more vacuum chambers containing one or more mass analyzers). One or more power supplies can supply power to the electrospray electrode with appropriate voltages for ionizing the analytes in either positive ion mode (analytes in the sample are protonated, generally forming cations to be analyzed) or negative ion mode (analytes in the sample are deprotonated, generally forming anions to be analyzed). Further, the ion source 110 can be nebulizer-assisted or non-nebulizer assisted. In some embodiments, ionization can also be promoted with the use of a heater 118, for example, to heat the ionization chamber so as to promote desolvation of the liquid discharged from the ion source probe 114. It will be appreciated by those skilled in the art that the electrospray ion source 110 is just one example of an ion source suitable for use with leak detection systems described herein, and that any known or hereafter developed ion source for generating ions from a liquid sample may be modified in accordance with the present teachings.

It will also be appreciated by a person skilled in the art and in light of the teachings herein that the mass spectrometer (not shown) is generally configured to process (e.g., filter, sort, dissociate, detect, etc.) sample ions generated by the ion source 110 and can have a variety of configurations. By way of non-limiting example, the mass spectrometer can be a triple quadrupole mass spectrometer, quadrupole time of flights, Orbitrap or other Fourier transform mass spectrometry systems, or any other mass analyzer known in the art or hereafter developed.

As noted above, the leak detection system 130 comprises a collection basin 140 into which leaked fluid can flow. The collection basin 140 can have a variety of configurations but generally defines an internal volume 140a into which the leaked fluid can be contained. For example, as shown in FIG. 1, the collection basin 140 comprises a base 142 and at least one sidewall 144 extending upward therefrom so as to define a frusto-conical internal volume 140a through which the proximal, inlet end 114a of the ion source conduit can at least partially extend. In various aspects, the basin 140 generally surrounds the proximal, inlet end 114a such that any fluid that leaks therefrom (e.g., due to improper fitting of the proximal inlet end 114a with a sample source, backflow from a clogged electrospray electrode) flows downward due to gravity into the collection basin 140. It will be appreciated that the collection basin 140 can be coupled to the proximal inlet end 114a of the ion source conduit in a variety manners. For example, as shown in the example of FIG. 1, an inner surface of a bore 142a in the base 142 may comprise a sealing surface (e.g., O-ring 142b, ferrule within a threaded connector, etc.) that is configured to be disposed (e.g., seal) against an external surface portion of the proximal inlet end 114a of the conduit.

As shown in the example of FIG. 1, the leak detection system 130 may also comprise a drainage tube 146 that defines a fluid pathway through which fluid may be removed from the internal volume 140a to a location outside of the collection basin 140. For example, the drainage tube 146 may comprise a lumen extending between an inlet 146a in fluid communication with the internal volume 140a and an outlet 146b. In certain aspects, the drainage tube 146 may extend a sufficient distance from the basin 140 that the outlet end 146b may be disposed within a waste container, for example, to contain leakage fluid captured by the collection basin 140. Alternatively, the outlet 146b of the drainage tube 146 may be configured to couple to one or more additional conduits, channels, tubing, pipes, etc. to provide a flow pathway from the internal volume 140a of the collection basin 140. In various aspects, the inlet 146a of the drainage tube 146 may be disposed at the lowest point within the basin 140 as shown in FIG. 1 such that any fluid contained within the basin 140 immediately flows into the drainage tube 146. Alternatively, in some aspects, the inlet 146a of the drainage tube 146 may be separated by a distance from the base 142 such that a volume of fluid may be retained within the internal volume 140a prior to flowing into the drainage tube 146, for example. In some aspects, such a configuration can allow for the collection of any temporary leaks that occur when coupling the inlet end 114a of the ion source conduit to a sample conduit without causing the detection of a leak event, as discussed otherwise herein.

As noted above, the leak detection system 130 additionally includes a sensor 150 that is generally configured to generate a signal indicative of liquid being within the collection basin 140. The sensor 150 may be configured to indicate the presence of fluid in a variety of manners. By way of non-limiting example, the sensor 150 may be configured to indicate the presence of fluid within the collection basin and/or drainage tube based on changes in characteristics related to electrical, thermal, optical, acoustic, mechanical, or flow properties. In some exemplary aspects, the sensor 150 may comprise a pair of electrodes disposed within the base 142, with the capacitance between the electrodes changing depending on whether the space therebetween is air or a liquid. In this manner, a change in capacitance between the electrodes can indicate fluid being collected within the internal volume 140a. Though the example sensor 150 of FIG. 1 is shown as being disposed in the base 142, the sensor 150 may alternatively be disposed in the sidewall 144 so as to detect a liquid level within the basin 140 only upon a certain volume of leaked fluids being collected. By way of example, the sensor 150 may be separated by a distance from the base 142 such that a volume of fluid may be retained within the internal volume 140a prior to the sensor 150 indicating the presence of fluid. In this manner, the basin 140 may be able to collect a small volume of fluid without causing the indication of a leak event, as discussed otherwise herein.

It will be appreciated that a sensor for detecting changes in capacitance due to the presence of a leaked fluid is just one example of an electrical sensor for identifying that a leak has occurred. By way of further non-limiting example, an electrical sensor suitable for use in accordance with various aspects of the present teachings may be configured to detect when a conductive leaked fluid (e.g., comprising water) is present by completing a circuit between two spaced electrodes. Indeed, it will be appreciated that any known or hereafter developed fluid sensing mechanism may be modified in accordance with the present teachings to generate signals indicative of leaked fluid within the basin 140 and/or drainage tube 146. For example, in addition to the example electrical techniques described above, the sensor 150 may be configured to indicate the presence of fluid within the collection basin and/or drainage tube based on changes in thermal characteristics (e.g., temperature), optical characteristics (e.g., transparency, optical refraction, absorption), mechanical characteristics (e.g., using a float), acoustic characteristics (e.g., acoustic reflection), and/or flow characteristics (e.g., pressure, flow rate). An optical sensor based on refraction, for example, can utilize a light source (e.g., LED) that can be detected by a detector (e.g., phototransistor), wherein fluid between the source and detector may refract the light, thereby altering the intensity of the light detected by the detector. Acoustic sensors can likewise determine changes in the detected signal based on the effect of the fluid on detected ultrasonic energy, for example.

As schematically depicted in FIG. 1, the computer system 160 (e.g., containing a processor) is communicatively coupled to the sensor 150 so as to receive signals generated thereby. In accordance with various aspects of the present teachings, the computer system 160 can be configured to, in response to receiving signals from the sensor 150 indicative of fluid within the collection basin 140, perform a variety of actions so as to mitigate the effects of a leakage. In certain example aspects, the computer system 160 can cause an operator of the system 100 to be alerted of a leak due to the presence of fluid within the collection basin 140. By way of example, a visual alert may be generated on a user interface of the computer system 160 (or another computer system operatively coupled thereto) and/or an audible alert can be sounded (e.g., by speakers associated with the computer system 160) to notify the operator of a leak condition. In some additional or alternative aspects, the computer system 160 can cause the experiment to be terminated such that the sample liquid stops flowing from the sample source into the inlet end 114a of the ion source conduit. By way of example, a pump for delivering the sample liquid from a reservoir and/or to an in-line LC column may be caused to discontinue pumping by the computer system 160 in response to the determination of a leak event. Additionally or alternatively, in some aspects, the computer system 160 can terminate the operation of the ion source 110 and/or the downstream MS system (not shown), for example, until the leak has been resolved.

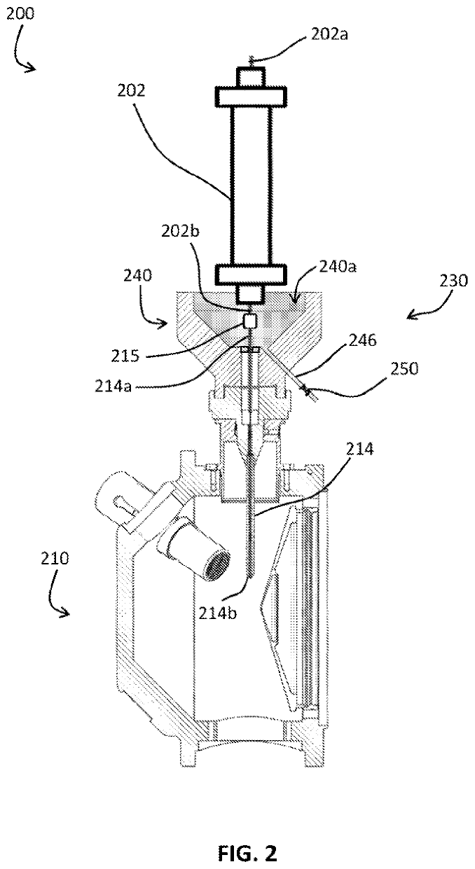

With reference now to FIG. 2, another exemplary MS system 200 having a leak detection system 230 in accordance with various aspects of the present teachings is depicted for capturing and/or identifying leaks at the interface between an ion source 210 (similar to ion source 110 of FIG. 1) and an LC column 202 as the sample source. As shown in FIG. 2, the outlet end 202b of the LC column 202 and the inlet end 214a of ion source conduit are fluidically coupled such that the eluate from the LC column 202 can be delivered to the discharge end 214b of the ion source 210. By way of example, one or both of the outlet end 202b and inlet end 214a may terminate in a liquid coupler 215 (e.g., each may end in corresponding couplers), which enables the formation of a fluid pathway between the LC column 202 and the ion source 210. It will be appreciated that any fluidic coupling mechanism known or hereafter developed may be utilized on the outlet end 202a and/or inlet end 214a to form a fluid pathway between the LC column 202 and the ion source 210 (e.g., barbed, tapered, snap-fit, interference, compression, and threaded fittings or connectors).

Leak detection system 230 is similar to leak detection system 130 of FIG. 1 in that it contains a collection basin 240, a sensor 250 for indicating leakage, and a computer system (not shown) for receiving signals generated by the sensor 250. However, whereas the sensor 130 in the leak detection system 230 of FIG. 1 is configured to indicate a leak through detection of fluid within the internal volume 140a of the collection basin 140, the sensor 250 of FIG. 2 is instead disposed within the drainage tube 246 so as to indicate the presence of fluid within the tube 246 as the fluid drains (e.g., due to gravity) from the collection basin 240. As above, it will be appreciated that the sensor 250 may be configured to indicate the presence of fluid within the drainage tube 246 using a variety of techniques (e.g., changes in capacitance, temperature, optically, acoustically). In some example aspects, the sensor 250 may be configured to detect fluid flow through the drainage tube 246 directly or indirectly, for example, due to pressure differences at various points within the flowing fluid or the revolution of a turbine disposed in the fluid flow pathway.

In addition to capturing leakage from the interface between the LC column 202 and ion source 210, it will be appreciated that the collection basin 240 may also be configured to capture any fluid leaking from the proximal, inlet end 202a of the LC column 202. For example, a poor fluid connection at the inlet end 202a of the LC column 202a may result in liquid flowing down the LC column 202 into the internal volume 240a of the collection basin 240 due to gravity, whereby it can drain through the drainage tube 246 for detection by sensor 250.

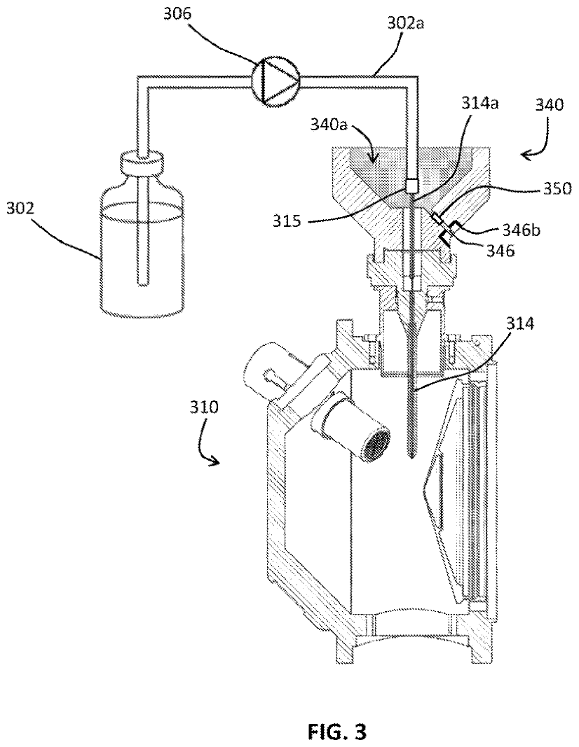

With reference now to FIG. 3, a portion of another example MS system 300 having a leak detection system 330 in accordance with various aspects of the present teachings is schematically depicted. As shown, the exemplary leak detection system 330 is configured to capture and/or identify leaks from the fluidic coupling interface (e.g., fluid coupler(s) 315) coupling the conduit (e.g., tubing 302a) extending between a sample reservoir 302 and the ion source 310. For example, one or both of the outlet end of tubing 302a and inlet end 314a may terminate in a liquid coupler 315 (e.g., each may end in corresponding couplers), which enables the formation of a fluid pathway between the reservoir 302 and the ion source 310. As discussed otherwise herein, a computer system (not shown) of the leak detection system 330 can be configured to stop the pump 306 upon detection of a leak based on signals received from sensor 350. Additionally, as shown in FIG. 3, it will be appreciated in light of the present teachings that the outlet end 346b of the drainage tube 346 extending from the internal volume 340a of collection basin 340 need not extend beyond the sidewall of the collection basin 340 as shown above in FIG. 1, for example. Rather, as shown in FIG. 3, the drainage tube 346 terminates in an outlet end comprising a fluid coupler (e.g., threaded female port 346b) to allow for removal of fluid from the internal volume 340 to a waste container (not shown) by coupling another fluid conduit to the port 346b.

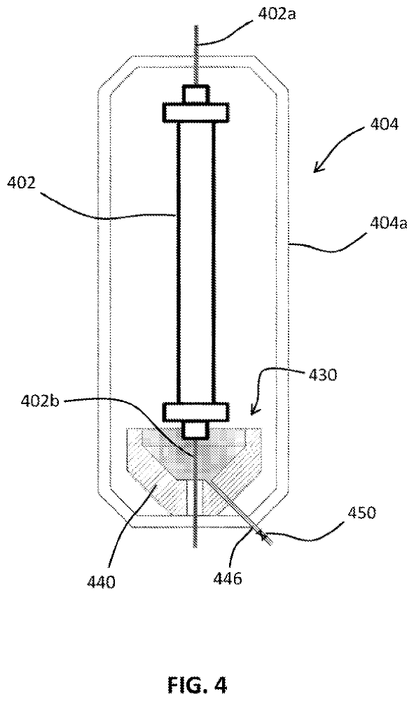

With reference now to FIG. 4, a portion of another exemplary leak detection system 430 in accordance with various aspects of the present teachings is depicted. Rather than sitting against the ion source housing 112 as with the collection basin 140 of FIG. 1, the collection basin 440 is within an LC oven 404 within which the LC column 402 and one or more heaters are disposed. As shown, a conduit 414 extends from the ion source (not shown) through the oven housing 404a to fluidically couple the LC column 402 to the ion source. As discussed above, the sensor 450 may be configured to indicate the presence of fluid within the drainage tube 446 using a variety of techniques. For example, the sensor 450, which is disposed outside the LC oven 440, may be configured to detect fluid within the drainage tube 446 based on temperature as any fluid draining from within the LC oven 404 may be warmer than the ambient temperature.

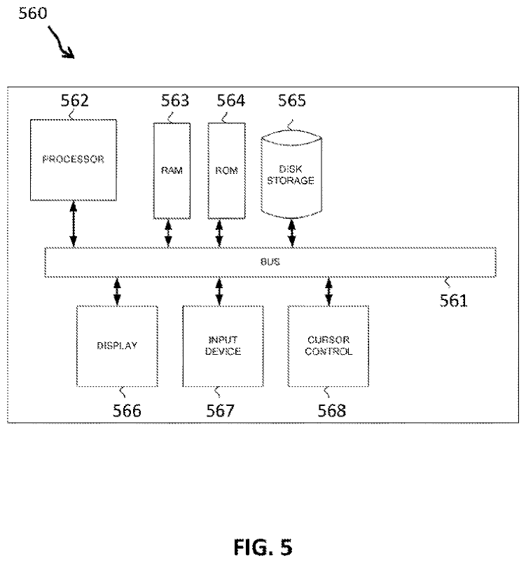

FIG. 5 is a block diagram that illustrates a computer system 560, upon which embodiments of the present teachings may be implemented. Computer system 560 includes a bus 561 or other communication mechanism for communicating information, and a processor 562 coupled with bus 561 for processing information. Computer system 560 also includes a memory 563, which can be a random access memory (RAM) or other dynamic storage device, coupled to bus 561 for storing instructions to be executed by processor 562. Memory 563 also may be used for storing temporary variables or other intermediate information during execution of instructions to be executed by processor 562. Computer system 560 further includes a read only memory (ROM) 564 or other static storage device coupled to bus 561 for storing static information and instructions for processor 562. A storage device 565, such as a magnetic disk or optical disk, is provided and coupled to bus 561 for storing information and instructions.

Computer system 560 may be coupled via bus 561 to a display 566, such as a cathode ray tube (CRT) or liquid crystal display (LCD), for displaying information to a computer user. By way of example, upon the determination of a leak condition by processor 562, an alert may be provided on the display 566 to notify the user that a leak has been detected and/or the experiment has been terminated. An input device 567, including alphanumeric and other keys, is coupled to bus 562 for communicating information and command selections to processor 562. Another type of user input device is cursor control 568, such as a mouse, a trackball or cursor direction keys for communicating direction information and command selections to processor 562 and for controlling cursor movement on display 566. This input device typically has two degrees of freedom in two axes, a first axis (i.e., x) and a second axis (i.e., y), that allows the device to specify positions in a plane. In accordance with various aspects of the present teachings, a user may be able to use the input devices 567, 568 to activate leak detection alerts to be provided, for example, in an instance in which the user intends to leave the MS experiment unattended for an extended period of time.

A computer system 560 can perform the present teachings. Consistent with certain implementations of the present teachings, results are provided by computer system 560 in response to processor 562 executing one or more sequences of one or more instructions contained in memory 563. Such instructions may be read into memory 563 from another computer-readable medium, such as storage device 565. Execution of the sequences of instructions contained in memory 563 causes processor 562 to perform the process described herein. Alternatively, hard-wired circuitry may be used in place of or in combination with software instructions to implement the present teachings. Thus, implementations of the present teachings are not limited to any specific combination of hardware circuitry and software. For example, the present teachings may be performed by a system that includes one or more distinct software modules for perform a method for detecting leaks in accordance with various embodiments (e.g., a sensor module, an alert module, an experiment termination module).

In various embodiments, computer system 560 can be connected to one or more other computer systems, like computer system 560, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example. As discussed above, for example, the computer system 560 may be configured to communicate with a remote computing system, which may be able to provide an alert to a user via the user's personal electronic device (e.g., via a text message, telephone call, push notification, etc.).

The term “computer-readable medium” as used herein refers to any media that participates in providing instructions to processor 562 for execution. Such a medium may take many forms, including but not limited to, non-volatile media, volatile media, and transmission media. Non-volatile media includes, for example, optical or magnetic disks, such as storage device 565. Volatile media includes dynamic memory, such as memory 563. Transmission media includes coaxial cables, copper wire, and fiber optics, including the wires that comprise bus 561.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 562 for execution. For example, the instructions may initially be carried on the magnetic disk of a remote computer. The remote computer can load the instructions into its dynamic memory and send the instructions over a telephone line using a modem. A modem local to computer system 560 can receive the data on the telephone line and use an infra-red transmitter to convert the data to an infra-red signal. An infra-red detector coupled to bus 561 can receive the data carried in the infra-red signal and place the data on bus 561. Bus 561 carries the data to memory 563, from which processor 562 retrieves and executes the instructions. The instructions received by memory 563 may optionally be stored on storage device 565 either before or after execution by processor 562.

The descriptions herein of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software, though the present teachings may be implemented as a combination of hardware and software or in hardware alone. The present teachings may be implemented with both object-oriented and non-object-oriented programming systems.

The section headings used herein are for organizational purposes only and are not to be construed as limiting. While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

What is claimed is:

1. A liquid leak detection system, comprising:
a collection basin for containing an internal volume, wherein the collection basin is configured to couple to a proximal end of a conduit in fluid communication with a discharge end of an ion source of a mass spectrometer such that the proximal end of the conduit extends through the internal volume of the collection basin;
a drainage tube having an inlet end opening into the internal volume of the collection basin and configured to drain liquid from the internal volume of the collection basin; and
a sensor disposed within either one or both of the basin and the drainage tube, the sensor configured to generate a signal indicative of liquid within the internal volume of the collection basin or the drainage tube.

2. The system of claim 1, wherein the drainage tube comprises an outlet end configured to discharge liquid received through the inlet end.

3. The system of claim 2, further comprising a waste container for receiving liquid discharged from the outlet end of the drainage tube.

4. The system of claim 1, wherein the collection basin comprises a base and a sidewall extending from the base, wherein the base is disposed below a level of the proximal end of the conduit.

5. The system of claim 4, wherein the base is disposed between the proximal end of the conduit and the discharge end of the ion source.

6. The system of claim 1, wherein the proximal end of the conduit comprises a fluid connector for coupling to a sample source to be ionized by the ion source.

7. The system of claim 6, wherein the sample source comprises a liquid chromatography column.

8. The system of claim 7, wherein an outlet of the liquid chromatography column is configured to couple to the fluid connector.

9. The system of claim 7, wherein a leak from an inlet of the liquid chromatography column is configured to flow into the collection basin.

10. The system of claim 7, wherein the collection basin is disposed within a column oven for heating the liquid chromatography column.

11. The system of claim 10, wherein the sensor is disposed within the column oven.

12. The system of claim 6, wherein the sample source comprises a reservoir of liquid sample and wherein a sample conduit in fluid communication with the reservoir terminates in a distal end configured to fluidly couple to the fluid connector.

13. The system of claim 12, further comprising a pumping mechanism for transporting fluid from the reservoir through the sample conduit.

14. The system of claim 12, wherein the ion source comprises an electrospray probe configured to discharge the liquid sample from the discharge end into an ionization chamber having an orifice for receiving ions into the mass spectrometer.

15. The system of claim 1, wherein the sensor is configured to detect liquid within the internal volume of the collection basin.

16. The system of claim 1, wherein the sensor is configured to detect liquid within the drainage tube.

17. The system of claim 1, wherein the sensor is configured to detect changes in capacitance.

18. The system of claim 1, wherein the sensor is coupled to a processor, and wherein the processor is configured to, upon receiving a signal indicative of a leak, either (a) cause an experiment to be terminated, (b) cause a user to be alerted, or (c) cause the experiment to be terminated and cause the user to be alerted.

19. (canceled)

20. A method of operating a mass spectrometer, comprising:
receiving, from a sensor, a signal indicative of liquid within a collection basin or a drainage tube associated with the mass spectrometer, wherein the collection basin is coupled to a proximal end of a conduit in fluid communication with a discharge end of an ion source of the mass spectrometer such that the proximal end of the conduit extends into an internal volume of the collection basin, and wherein the drainage tube comprises an inlet end opening into the internal volume of the collection basin and configured to drain liquid from the internal volume of the collection basin, and wherein the sensor is disposed within either one or both of the collection basin and the drainage tube; and
causing a user of the mass spectrometer to be alerted of a leak condition based on the signal received from the sensor.

21. The method of claim 20, further comprising causing an experiment utilizing the ion source and mass spectrometer to be terminated based on the signal received from the sensor.
